(19) United States
(12) Patent Application Publication
(10) Pub. No.: US 2022/0335039 A1
(43) Pub. Date: Oct. 20, 2022

(54) DATA FILE DISTRIBUTION METHOD AND EQUIPMENT, SMART DEVICE AND COMPUTER STORAGE MEDIUM

(71) Applicant: Jinan University, Guangzhou (CN)

(72) Inventors: Jilian Zhang, Guangzhou (CN); Jian Weng, Guangzhou (CN); Yongdong Wu, Guangzhou (CN); Guanggang Geng, Guangzhou (CN)

(21) Appl. No.: 17/447,615

(22) Filed: Sep. 14, 2021

(30) Foreign Application Priority Data
Apr. 14, 2021 (CN) 202110404424.4

(51) Int. Cl. G06F 16/242; G06F 16/182

(52) U.S. Cl. CPC G06F 16/244; G06F 16/2448; G06F 16/182

(57) ABSTRACT

Disclosed are a data file distribution method and equipment, a smart device and a computer storage medium. The method includes the following operations: sorting data files according to an access frequency of each data file, a sorting mode including an ascending order or a descending order; dividing the data files into at least two data blocks according to a sorted order, numbers of data files in the at least two data blocks being equal; merging the data files in each of the at least two data blocks in pairs to update the data files; sorting the updated data files according to the access frequency of each data file until the numbers of the data files are equal to numbers of distributed nodes; and placing the data files on corresponding distributed nodes.

### CROSS-REFERENCE TO RELATED APPLICATIONS

This application claims priority to Chinese Patent Application No. 202110404424.4, filed on Apr. 14, 2021, the entire disclosure of which is incorporated herein by reference.

### TECHNICAL FIELD

The present disclosure relates to the technical field of cloud computing, in particular to a data file distribution method and equipment, a smart device and a computer storage medium.

### BACKGROUND

In the cloud computing environment, multiple computers with computing, storage, and communication functions are connected to each other. Each computer acts as a node, thus forming a distributed system composed of multiple nodes, which can perform data storage or other distributed computing tasks, such as distributed machine learning on each node in parallel. In the related art, during the process of placing data files on computer nodes, it is impossible to reasonably distribute and place data files on various computer nodes in a balanced manner according to the distributed environment. As a result, the unbalanced distribution of data files leads to load-balancing problem, which is not conducive to the stability of the distributed system.

### SUMMARY

The main objective of the present disclosure is to provide a data file distribution method and equipment, a smart device and a computer storage medium, which aims to solve the problem that the unbalanced distribution of data files leads to load-balancing problem.

In order to achieve the objective, the present disclosure provides a data file distribution method.

In an embodiment, the data file distribution method includes the following operations:

sorting data files according to an access frequency of each data file, a sorting mode including an ascending order or a descending order;

dividing the data files into at least two data blocks according to a sorted order, numbers of data files in the at least two data blocks being equal;

merging the data files in each of the at least two data blocks in pairs to update the data files;

sorting the updated data files according to the access frequency of each data file until the numbers of the data files are equal to numbers of distributed nodes; and

placing the data files on corresponding distributed nodes.

In an embodiment, the operation of dividing the data files into at least two data blocks according to a sorted order includes:

determining a target number according to the numbers of the data files and the numbers of the distributed nodes; and

dividing the data files into data blocks with the target number according to the sorted order.

In an embodiment, the operation of determining a target number according to the numbers of the data files and the numbers of the distributed nodes includes:

obtaining a first ratio between the numbers of the data files and a multiple of the numbers of the distributed nodes; and

using the first ratio as the target number.

In an embodiment, before the operation of sorting data files according to an access frequency of each data file, the method further includes:

obtaining a second ratio between the numbers of the data files and the numbers of the distributed nodes; and

when the second ratio is a non-integer, generating virtual files as data files, and setting access frequencies of the generated data files to zero.

In an embodiment, the operation of merging the data files in each data block in pairs to update the data files includes:

merging a current first target file and a current second target file in a data column composed of data files in each data block to obtain updated data files, the current first target file being a data file at a first position of the data column, and the current second target file being a data file at a last position of the data column when merging for the first time;

updating a data file next to the current first target file in the data column as a new first target file, and updating a data file previous to the current second target file in the data column as a new second target file; and

merging the new first target file and the new second target file in the data column composed of the data files in each data block to obtain updated data files, until all the data files in each data block are merged.

In an embodiment, an access frequency of a new data file obtained by merging two data files is a sum of access frequencies of the two data files before merging.

In an embodiment, the operation of placing the data files on corresponding distributed nodes includes:

placing the current first target file and the current second target file in the data column composed of data files in each data block to a first distributed node; and

placing the data file next to the current first target file in the data column and the data file previous to the current second target file in the data column to a second distributed node, until all the data files in all the data blocks are placed on corresponding distributed nodes.

In order to achieve the above objective, the present disclosure further provides a data file distribution equipment, including:

a sorting module for sorting data files according to an access frequency of each data file, a sorting mode including an ascending order or a descending order;

a dividing module for dividing the data files into at least two data blocks according to a sorted order, numbers of the data files in each of the at least two data blocks being equal;

a merging module for merging the data files in each of the at least two data blocks in pairs to update the data files; and

a placing module for placing the data files on corresponding distributed nodes.

In order to achieve the above objective, the present disclosure further provides a smart device, including a memory, a processor, and a data file distribution program stored in the memory and executable on the processor, the data file distribution program, when executed by the processor, implements operations of the data file distribution method as described above.

In order to achieve the above objective, the present disclosure further provides a computer readable storage medium, wherein a data file distribution program is stored in the computer readable storage medium, the data file distribution program, when executed by a processor, implements operations of the data file distribution method as described above.

During the process of placing data files on computer nodes, it is impossible to reasonably distribute and place data files on various computer nodes in a balanced manner according to a distributed environment. Therefore, the present disclosure provides a data file distribution method and equipment, a smart device and a computer storage medium. The method includes: sorting data files according to an access frequency of each data file, a sorting mode including an ascending order or a descending order; dividing the data files into at least two data blocks according to a sorted order, numbers of the at least two data files in each data block being equal; merging the data files in each of the at least two data blocks in pairs to update the data files; sorting the updated data files according to the access frequency of each data file until the numbers of the data files are equal to numbers of distributed nodes; and placing the data files on corresponding distributed nodes, which solves the problem of load-balancing caused by the unbalanced data file distribution in the prior art, and improves the stability of the distributed system.

### BRIEF DESCRIPTION OF THE DRAWINGS

FIG. 1 is a schematic structural diagram of a smart device according to an embodiment of the present disclosure.

FIG. 2 is a schematic flowchart of a data file distribution method according to a first embodiment of the present disclosure.

FIG. 3 is a schematic flowchart of the data file distribution method according to a second embodiment of the present disclosure.

FIG. 4 is a schematic flowchart of the data file distribution method according to a third embodiment of the present disclosure.

FIG. 5 is a schematic flowchart of the data file distribution method according to a fourth embodiment of the present disclosure.

FIG. 6 is a schematic flowchart of the data file distribution method according to a fifth embodiment of the present disclosure.

FIG. 7 is a schematic flowchart of the data file distribution method according to a sixth embodiment of the present disclosure.

FIG. 8 is a schematic diagram showing data file distribution.

FIG. 9 is a schematic structural diagram of a data file distribution equipment according to the present disclosure.

The realization of the objective, functional characteristics, and advantages of the present disclosure are further described with reference to the accompanying drawings.

### DETAILED DESCRIPTION OF THE EMBODIMENTS

It should be understood that the specific embodiments described here are only used to explain the present disclosure, but not to limit the present disclosure.

The present disclosure is to solve the problem of load-balancing caused by the unbalanced distribution of data files in the related art. The data file distribution method of the present disclosure includes: sorting data files according to an access frequency of each data file, a sorting mode including an ascending order or a descending order; dividing the data files into at least two data blocks according to a sorted order, numbers of the data files in the at least two data blocks being equal; merging the data files in each of the at least two data blocks in pairs to update the data files; sorting the updated data files according to the access frequency of each data file until the numbers of the data files are equal to numbers of distributed nodes; and placing the data files on corresponding distributed nodes. Thus, the stability of the distributed system is improved.

In order to better understand the above technical solutions, the exemplary embodiments of the present disclosure will be described in more detail with reference to the accompanying drawings. Although the drawings show exemplary embodiments of the present disclosure, it should be understood that the present disclosure can be implemented in various forms and should not be limited by the embodiments set forth herein. On the contrary, these embodiments are provided for a more thorough understanding of the present disclosure and to fully convey the scope of the present disclosure to those skilled in the art.

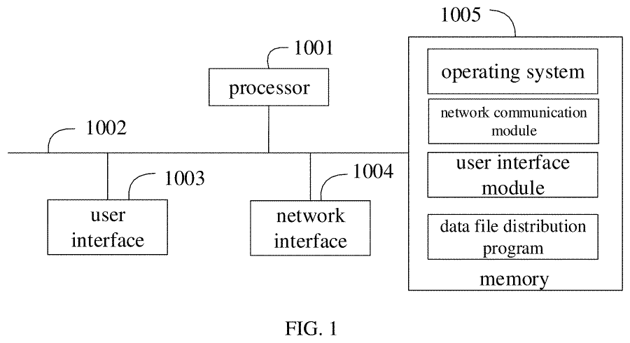

As shown in FIG. 1, FIG. 1 is a schematic structural diagram of a hardware operating environment according to an embodiment of the present disclosure.

It should be noted that FIG. 1 can be a schematic architectural diagram of the hardware operating environment of a smart device.

As shown in FIG. 1, the smart device can include a processor 1001, such as a CPU, a memory 1005, a user interface 1003, a network interface 1004, and a communication bus 1002. The communication bus 1002 is configured to implement communication between the components. The user interface 1003 may include a display, an input unit such as a keyboard. The user interface 1003 may also include a standard wired interface and a wireless interface. The network interface 1004 may further include a standard wired interface and a wireless interface (such as a WI-FI interface). The memory 1005 may be a high-speed random access memory (RAM) or a non-volatile memory, such as a magnetic disk memory. The memory 1005 may also be a storage device independent of the foregoing processor 1001.

Those skilled in the art should understand that the structure of the smart device shown in FIG. 1 does not constitute a limitation on the smart device, and the smart device may include more or fewer components, a combination of some components, or differently arranged components than shown in the figure.

As shown in FIG. 1, as a computer storage medium, the memory 1005 may include an operating system, a network communication module, a user interface module, and a data file distribution program. The operating system is the program that manages and controls the hardware and software resources of the smart device, the data file distribution program, and the operation of other software or programs.

In the smart device shown in FIG. 1, the user interface 1003 is mainly configured to connect to the terminal and perform data communication with the terminal. The network interface 1004 is mainly configured to connected to a background server and perform data communication with the background server; the processor 1001 can be configured to call the data file distribution program stored in the memory 1005.

In this embodiment, the smart device includes: a memory 1005, a processor 1001, and a data file distribution program stored in the memory and executable on the processor.

In an embodiment of the present disclosure, the processor 1001 can be configured to call the data file distribution program stored in the memory 1005, and perform the following operations:

sorting data files according to an access frequency of each data file, a sorting mode including an ascending order or a descending order;

dividing data files into at least two data blocks according to a sorted order, numbers of data files in the at least two data blocks being equal;

merging the data files in each of the at least two data blocks in pairs to update the data files;

sorting the updated data files according to the access frequency of each data file until the numbers of the data files are equal to numbers of distributed nodes; and

placing the data files on corresponding distributed nodes.

In an embodiment of the present disclosure, the processor 1001 can be configured to call the data file distribution program stored in the memory 1005, and perform the following operations:

determining a target number according to the numbers of the data files and the numbers of the distributed nodes; and

dividing the data files into data blocks with the target number according to a sorted order.

In an embodiment of the present disclosure, the processor 1001 can be configured to call the data file distribution program stored in the memory 1005, and perform the following operations:

obtaining a first ratio between the numbers of the data files and a multiple of the numbers of distributed nodes; and

using the first ratio as the target number.

In an embodiment of the present disclosure, the processor 1001 can be configured to call the data file distribution program stored in the memory 1005, and perform the following operations:

obtaining a second ratio between the numbers of the data files and the numbers of the distributed nodes; and

when the second ratio is a non-integer, generating virtual files as data files, and setting access frequencies of the generated data files to zero.

In an embodiment of the present disclosure, the processor 1001 can be configured to call the data file distribution program stored in the memory 1005, and perform the following operations:

merging a current first target file and a current second target file in a data column composed of data files in each data block to obtain updated data files, when merging for the first time, the current first target file being a data file at a first position of the data column, and the current second target file being a data file at a last position of the data column;

updating a data file next to the current first target file in the data column as a new first target file, and updating a data file previous to the current second target file in the data column as a new second target file; and

merging the new first target file and the new second target file in the data column composed of the data files in each data block to obtain updated data files, until all the data files in each data block are merged.

In an embodiment of the present disclosure, the processor 1001 can be configured to call the data file distribution program stored in the memory 1005, and perform the following operations:

an access frequency of a new data file obtained by merging two data files is a sum of access frequencies of the two data files before merging.

In an embodiment of the present disclosure, the processor 1001 can be configured to call the data file distribution program stored in the memory 1005, and perform the following operations:

placing the current first target file and the current second target file in the data column composed of data files in each data block to a first distributed node; and

placing the data file next to the current first target file in the data column and the data file previous to the current second target file in the data column to a second distributed node, until all the data files in all the data blocks are placed on corresponding distributed nodes.

Since the smart device of the embodiment of the present disclosure is a smart device used to implement the method of the embodiment of the present disclosure, based on the method introduced in the embodiment of the present disclosure, those skilled in the art can understand the specific structure and various changes of the smart device, so it is not repeated here. All smart devices used in the methods of the embodiments of the present disclosure belong to the scope of the present disclosure. The sequence numbers of the above-mentioned embodiments of the present disclosure are only for description, and do not represent the advantages and disadvantages of the embodiments.

For software implementation, the technology described in the embodiments of the present disclosure can be implemented by modules (for example, procedures, functions, etc.)

that execute the functions described in the embodiments of the present disclosure. The software codes can be stored in the memory and executed by the processor. The memory can be implemented in the processor or external to the processor.

Based on the above structure, the embodiments of the present disclosure are proposed. The operating systems of the data file distribution method described in the present disclosure include, but are not limited to, Linux, Android, Windows 7 and Windows 10, etc. The data file distribution method can be applied to smart devices.

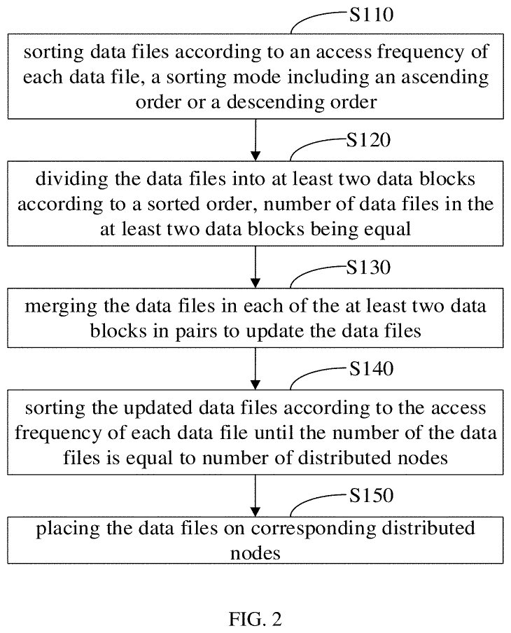

As shown in FIG. 2, FIG. 2 is a schematic flowchart of a data file distribution method according to a first embodiment of the present disclosure. The data file distribution method includes the following operations:

Operation S110, sorting data files according to an access frequency of each data file, a sorting mode including an ascending order or a descending order.

In this embodiment, in the cloud computing environment, multiple computer nodes with computing, storage, and communication functions are connected through networks to form a distributed system composed of multiple computer nodes, and with the cooperation of unified distributed system software, such as Hadoop, Zookeeper and other distributed system software, various data storage or distributed computing tasks can be performed on the nodes in parallel. In a distributed system, whether it is distributed storage, distributed machine learning or other application scenarios, data files are placed in each node according to a certain strategy, such that the CPU calculation load, data file read and write load, software service request load, network I/O load, etc. of the nodes in the entire distributed system are relatively balanced, and while ensuring the stability and reliability of the system, the resource utilization rate of the entire distributed system is maximized. The present disclosure provides a method for distributing data files in a distributed environment. This method can place multiple data files on corresponding computer nodes in a distributed environment according to the access frequency of the data files, so that the sums of the access frequencies of the data files placed on the nodes tends to be the same, so as to achieve the purpose of load balancing of the data files on the nodes in the distributed environment and improve the stability of the distributed system.

In this embodiment, the data files are also called files, which refer to any computer files that save data. These data files can be any type of data storage files, for example, image data files, audio data files, etc. The data files are generally stored in a specific database. When a data file is detected to be accessed once, the data table field that saves the data file will increase by one, thereby obtaining the access frequency of the data file. The sizes of the data files are inconsistent. In general, audio data files take up more memory space than image data files. If multiple audio data files that take up a lot of memory space are placed on the same computer node, and multiple image data files that take up less memory space are placed on another computer node, the loads on the computer nodes will be unbalanced. Therefore, it is necessary to sort the data files according to the access frequency of each data file, and the sorting mode includes the ascending order or the descending order. The descending order refers to sorting each data file according to the access frequency from largest to smallest, and the ascending order refers to sorting each data file according to the access frequencies from smallest to largest. For example, there is a set S={s1, s2, . . . , s12} containing 12 data files, the corresponding access frequency sequence is (12, 20, 10, 6, 9, 2, 32, 36, 23, 16, 4, 8). The data files are sorted in descending order according to the access frequencies of the data files, and the sorted data file sequence is (s8, s7, s9, s2, s10, s1, s3, s5, s12, s4, s11, s6), the corresponding access frequency sequence is (36, 32, 23, 20, 16, 12, 10, 9, 8, 6, 4, 2). The data files are sorted in ascending order according to the access frequencies of the data files, and the sorted data file sequence is (s6, s11, s4, s12, s5, s3, s1, s10, s2, s9, s7, s8), the corresponding access frequency sequence is (2, 4, 6, 8, 9, 10, 12, 16, 20, 23, 32, 36). It is important to note that the access frequency of each data file in the data file set is a positive integer. The present disclosure is described in a manner that the data files are sorted according to the access frequencies from largest to smallest, that is, the sorting mode is descending order, and the ascending order is similar to the descending order, and will not be repeated here.

Operation S120, dividing the data files into at least two data blocks according to a sorted order, numbers of data files in the at least two data blocks being equal.

In this embodiment, in order to facilitate the subsequent processing of the data files, it is necessary to divide the data files in ascending or descending order into at least two data blocks. At the same time, during the process of dividing, the data files in the set need to be divided equally from left to right or from right to left, so that the numbers of data files in all data blocks after division are equal. When the numbers of data files and the numbers of computer nodes are known, the number of data blocks that need to be divided is calculated according to the numbers of data files in the set and the numbers of computer nodes. The number of data blocks to be divided is equal to |S|/2B, S is the number of data files in the set, B is the number of computer nodes. For example, when there is a set containing 12 data files, it is necessary to balance the 12 data files on 3 computer nodes, then, it can be calculated that the number of data blocks that need to be divided is 2, the number of data files placed on each block is 6, and the number of data files placed on each computer node is 4. For example, the data file set (s8, s7, s9, s2, s10, s1, s3, s5, s12, s4, s11, s6) in operation S110 is divided into two blocks, block 1 (s8, s7, s9, s2, s10, s1) and block 2 (s3, s5, s12, s4, s11, s6) are obtained. The access frequencies of the corresponding data files in block 1 and block 2 are (36, 32, 23, 20, 16, 12) and (10, 9, 8, 6, 4, 2), respectively. Assuming that each data file is put into 1 bucket, there are 6 buckets in each block.

Operation S130, merging the data files in each of the at least two data blocks in pairs to update the data files.

In this embodiment, the data files in each data block are merged in pairs to obtain a new data file. Merging in pairs refers to merging the access frequency of the first data file in the data block and the access frequency of the last data file in the data block. The access frequency of the new data file obtained by the merging is the sum of the access frequencies of the two data files before the merging. For example, the access frequencies (36, 32, 23, 20, 16, 12) of the corresponding data files in block 1 (s8, s7, s9, s2, s10, s1) are merged in pairs, and the access frequencies (10, 9, 8, 6, 4, 2) of the corresponding data files in block 2 (s3, s5, s12, s4, s11, s6) are merged in pairs. Assuming that each data file in each block is put into 1 bucket, there are 6 buckets in each block, then after the data files in each block are merged in pairs, the merged result of block 1 becomes ({s8, s1}, {s7, s10}, {s9, s2}). Then, {s8, s1} forms a new bucket, {s7, s10} forms a new bucket, and {s9, s2} forms a new bucket. The access frequencies of these 3 new buckets are the sums of the access frequencies of the data files before the merging correspondingly, namely (48, 48, 43). Similarly, the merged result of block 2 becomes ({s3, s6}, {s5, s11}, {s12, s4}). The access frequencies of these three new buckets in block 2 are (12, 13, 14).

Operation S140, sorting the updated data files according to the access frequency of each data file until the numbers of the data files are equal to numbers of distributed nodes.

In this embodiment, after the first round of data files merging, the sum of the access frequencies of the data files corresponding to block 1 is (48, 48, 43), and the sum of the access frequencies of the data files corresponding to block 2 is (12, 13, 14), and the data files in each block cannot be merged in pairs again. Therefore, it is necessary to merge the access frequencies of the data files in block 1 and block 2 to obtain 6 new buckets, each of which contains two data files. Since the order of the access frequencies (48, 48, 43, 12, 13, 14) corresponding to the data files in the merged set is irregular, it is necessary to return to the operation of sorting the data files according to the access frequency of each data file. The data files in the merged set are sorted according to the access frequencies, the sorted bucket sequences ({s8, s1}, {s7, s10}, {s9, s2}, {s12, s4}, {s5, s11}, {s3, s6}) are obtained, that is, the bucket sequence contains six buckets, and the access frequency sequence of data files corresponding to each bucket is (48, 48, 43, 14, 13, 12). Then, whether to continue to divide the data files in the bucket is determined through calculation. In this process, the sorted bucket sequence is divided from left to right. Similarly, the number of data blocks that need to be divided is calculated according to the number of data files and the number of computer nodes, the number of data blocks that need to be divided is still equal to |S|/2B, at this time, the number of data files is 6 and the number of distributed nodes is 3, then the number of data blocks that need to be divided is 1. When the number of data blocks is 1, it indicates that there is no need to divide the sorted bucket sequence. The data files in the buckets in the bucket sequence ({s8, s1}, {s7, s10}, {s9, s2}, {s12, s4}, {s5, s11}, {s3, s6}) are merged in pairs, that is, the first bucket is merged with the sixth bucket, the second bucket is merged with the fifth bucket, and the third bucket is merged with the fourth bucket to obtain the merged result ({s8, s1, s3, s6}, {s7, s10, s5, s11}, {s9, s2, s12, s4}). The access frequencies of the three new buckets obtained after merging are the sums of the access frequencies of the data files in the buckets correspondingly, namely (48+12, 48+13, 43+14)=(60, 61, 57). At this time, there are 3 buckets, 4 data files are placed in each bucket, and the 4 data files in each bucket are updated to be a new data file, then each bucket corresponds to 1 new data file, that is, 3 new data files. At this time, the number of new data files is equal to the number of distributed nodes.

Operation S150, placing the data files on corresponding distributed nodes.

In this embodiment, when the data files are merged in pairs until the number of data files is equal to the number of distributed nodes, the data files are placed on the corresponding distributed nodes. For example, since the last round of merging results in 3 buckets, each bucket contains 4 data files, the division and merging process is over, and the final plan for placing data files on 3 distributed nodes is obtained. For example, the data file set {s8, s1, s3, s6} of the first bucket is be placed on computer node 1, the data file set {s7, s10, s5, s11} of the second bucket is placed on computer node 2, and the data file set {s9, s2, s12, s4} of the third bucket is placed on computer node 3. The data file access frequencies on these 3 nodes are (60, 61, 57). The maximum difference between the access frequencies of data file on the nodes is only 61−57=4, that is, the maximum difference of access frequency is about 4/(60+61+57)/3)*100%=6% of the average access frequency. It can be seen that the data file reading and writing on the three nodes is relatively balanced.

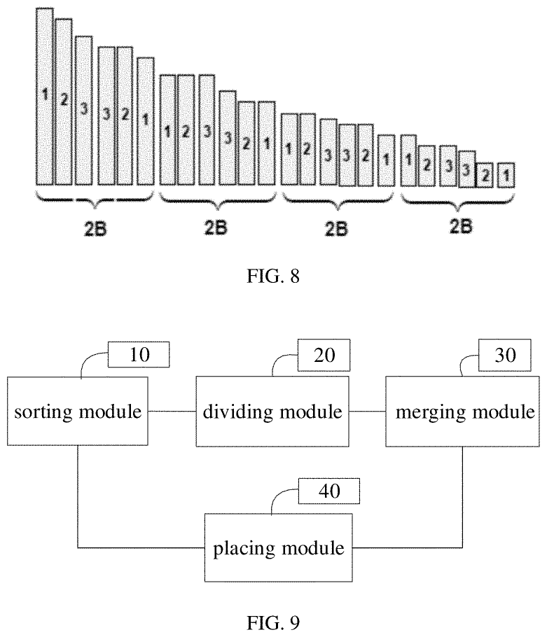

In this embodiment, as shown in FIG. 8, 24 data files are divided into 4 data blocks, each data block contains 2B=6 data files, that is, the total number of distributed computer nodes is B=3, and each node needs to place 24/3=8 data files. Each bar represents 1 data file, a height of the bar represents a value of access frequency, and the number on each bar represents the bucket in which the data file is to be placed.

In technical solutions of this embodiment, the data files are sorted according to the access frequency of each data file, and the data file is divided into at least two data blocks according to the sorted order, and the numbers of data files in all data blocks are equal. The data files in each data block are merged in pairs to update the data files, and the operation of performing the sorting of the data files according to the access frequency of each data file is repeated, until the number of data files reaches the number of distributed nodes, to obtain the strategy of which data files each computer node needs to be allocated with. Through this strategy, the data files are placed on the corresponding distributed nodes, which solves the problem of load-balancing caused by the unbalanced data file distribution in the related art, and improves the stability of the distributed system.

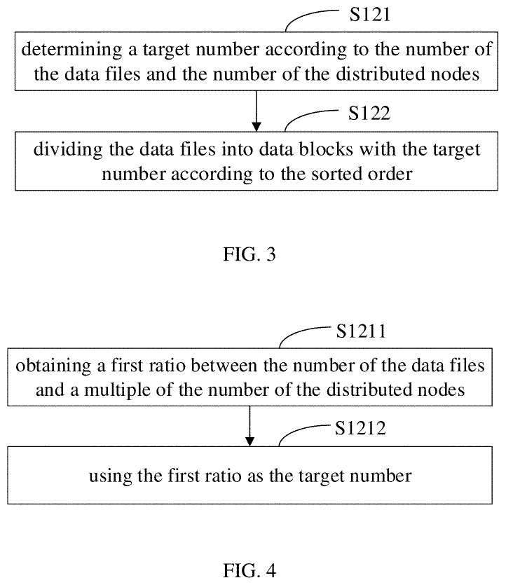

As shown in FIG. 3, FIG. 3 is a schematic flowchart of the data file distribution method according to a second embodiment of the present disclosure. Operations S121 to S122 in the second embodiment are detailed operations of operation S120 in the first embodiment, and the second embodiment includes the following operations:

Operation S121, determining a target number according to the numbers of the data files and the numbers of the distributed nodes; and

Operation S121, dividing the data files into data blocks with the target number according to the sorted order.

In this embodiment, the data files are obtained, the target number of data blocks that need to be divided is calculated according to the number of data files and the number of pre-set distributed nodes. The data files are sorted according to a preset sorting mode, the sorting mode includes the ascending order or the descending order, and data files are divided into the target number of data blocks according to the sorted order. The number of data blocks that need to be divided is calculated according to the number of data files in the set and the number of computer nodes, the number of data blocks to be divided is equal to |S|/2B, S is the number of data files in the set, and B is the number of computer nodes. For example, when there is a set containing 24 data files, when the 24 data files need to be evenly placed on 3 computer nodes, then the number of data blocks that need to be divided can be calculated to be 4 blocks.

In technical solutions of this embodiment, the target number is determined according to the number of the data files and the number of the distributed nodes, and the data files are divided into the target number of data blocks according to the sorted order, so as to reasonably divide the data files.

As shown in FIG. 4, FIG. 4 is a schematic flowchart of the data file distribution method according to a third embodiment of the present disclosure. Operations S1211 to S1212 in the third embodiment are detailed operations of operation S121 in the second embodiment, and the third embodiment includes the following operations:

Operation S1211, obtaining a first ratio between the number of the data files and a multiple of the number of the distributed nodes; and

Operation S1212, using the first ratio as the target number.

In this embodiment, there is a correlation between the target number of the data blocks and the number of the data files and the multiple of the number of the distributed nodes. According to the actual situation, the multiple of the number of the distributed nodes is 2, and the first ratio between the number of the data files and the multiple of the number of the distributed nodes is obtained. The first ratio is |S|/2B, and the first ratio is the target number of the data blocks, S is the number of the data files in the set, and B is the number of computer nodes. The final first ratio must be a positive integer, that is, the target number of the data blocks obtained by dividing is a positive integer.

In technical solutions of this embodiment, the first ratio between the number of the data files and the multiple of the number of the distributed nodes is obtained, and the first ratio is used as the target number, thereby obtaining the target number of the data blocks that need to be divided.

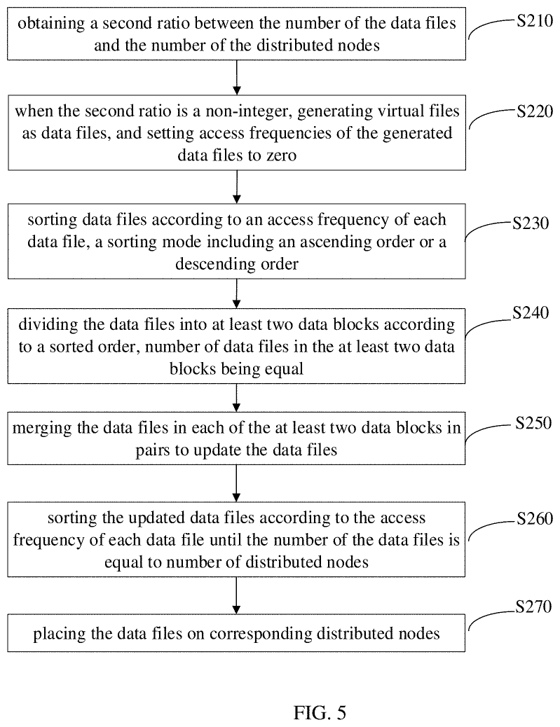

As shown in FIG. 5, FIG. 5 is a schematic flowchart of the data file distribution method according to a fourth embodiment of the present disclosure. Operation S210 to operation S220 in the fourth embodiment are before operation S110 in the first embodiment, and the fourth embodiment includes the following operations:

Operation S210, obtaining a second ratio between the number of the data files and the number of the distributed nodes; and

Operation S220, when the second ratio is a non-integer, generating virtual files as the data files, and setting access frequencies of the generated data files to zero.

In this embodiment, since the number of acquired data files may not be evenly placed on the distributed nodes, or the number of the data files cannot be evenly divided. For example, when the number of the data files obtained is 11, the number of the data files needs to be evenly placed on 3 computer nodes, and the number of the data blocks calculated according to |S|/2B is not a positive integer. Therefore, before sorting the data files, it is necessary to determine whether the same number of the data files can be placed uniformly on each computer node or whether the numbers of the data files in the divided data blocks are equal. During the determination process, the second ratio between the number of the data files and the number of the distributed nodes is obtained. When the second ratio is a non-integer number, a number of virtual files are added to a set of the data files, and an access frequency of each virtual file is set to 0. For example, there is a set of data files S={s1, s2, . . . , sn}. The access frequency of each data file in the set is a positive integer. Assuming that the number of computer nodes in a distributed environment is B. If |SI cannot divide B, several virtual data files s0 need to be added to S, and the access frequency of each virtual file is set to 0, such that the number of data files |S| can divide B, that is, |S| mod B=0, c=|S|/B is the number of data files that need to be placed on each computer node in a distributed environment.

Operation S230, sorting data files according to an access frequency of each data file, a sorting mode including an ascending order or a descending order;

Operation S240, dividing the data files into at least two data blocks according to a sorted order, number of the data files in each data block being equal;

Operation S250, merging the data files in each data block in pairs to update the data files;

Operation S260, sorting the updated data files according to the access frequency of each data file until the number of the data files is equal to number of distributed nodes; and

Operation S270, placing the data files on corresponding distributed nodes.

In technical solutions of this embodiment, the second ratio between the number of the data files and the number of the distributed nodes is obtained. When the second ratio is a non-integer, the virtual files are generated as the data files, and the access frequencies of the generated data files are set to zero, so that the number of the data files in each data block is equal.

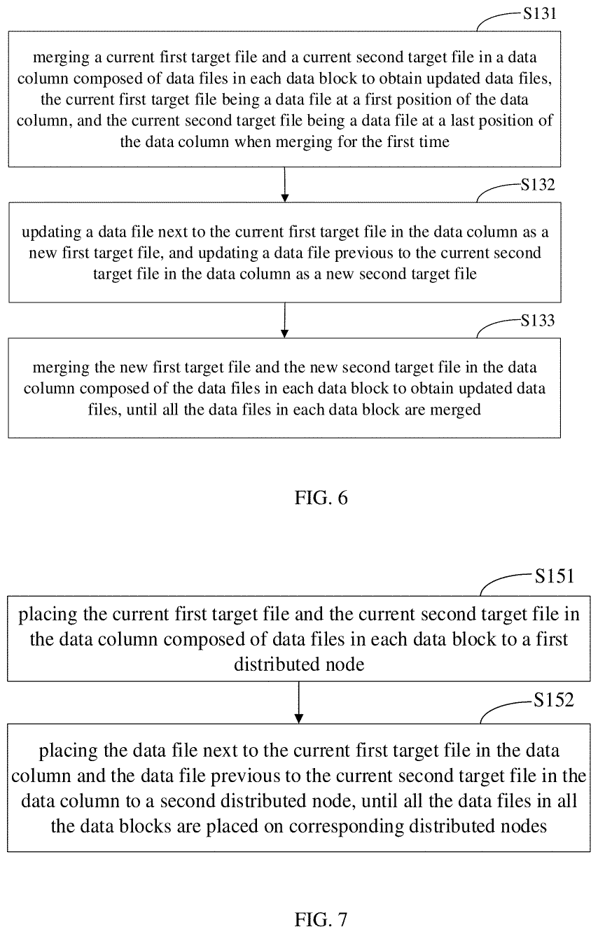

As shown in FIG. 6, FIG. 6 is a schematic flowchart of the data file distribution method according to a fifth embodiment of the present disclosure. Operations S131 to S133 in the fifth embodiment are detailed operations of operation S130 in the first embodiment, and the fifth embodiment includes the following operations:

Operation S131, merging a current first target file and a current second target file in a data column composed of the data files in each data block to obtain the updated data files, when merging for the first time, the current first target file being a data file at a first position of the data column, the current second target file being a data file at a last position of the data column;

Operation S132, updating a data file next to the current first target file in the data column as a new first target file, and updating a data file previous to the current second target file in the data column as a new second target file; and

Operation S133, merging the new first target file and the new second target file in the data column composed of the data files in each data block to obtain updated data files, until all the data files in each data block are merged.

In this embodiment, when the data files in the data set are divided into multiple data blocks, each data block corresponds to a data column composed of data files. The data files in the data column composed of data files in the data block are merged in pairs until all the data files in each data block are merged. The process of merging in pairs is: merging the current first target file and the current second target file in the data column to obtain the updated data files, when merging for the first time, the current first target file being the data file at the first position of the data column, the current second target file being the data file at the last position of the data column, taking a data file next to the current first target file in the data column as a new first target file, and taking a data file previous to the current second target file in the data column as a new second target file.

In this embodiment, each block is merged. The data files in the first bucket and the data files in the last bucket are merged to form a new bucket, the data file in the second bucket and the data file in the second to last bucket are merged to form a new bucket, that is, the data files in the i-th and 2B−i+1-th buckets are merged to form a new bucket. After the merging, each block will form B new buckets, each new bucket contains two data files, and the access frequency of the bucket is the sum of the access frequencies of the two data files. For example, the data file set (s8, s7, s9, s2, s10, s1, s3, s5, s12, s4, s11, s6) in operation S110 is divided into two blocks to obtain the data columns of block 1 (s8, s7, s9, s2, s10, s1) and the data columns of block 2 (s3, s5, s12, s4, s11, s6). Block 1 is taken as an example. When merging for the first time, s8 in the data column (s8, s7, s9, s2, s10, s1) of the block 1 is the first target file, s1 in the data column (s8, s7, s9, s2, s10, s1) of the block 1 is the second target file, s8 and s1 are merged to obtain the updated data files {s8, s1}. After s8 and s1 are merged, the data file s7 next to the current first target file in the data column of block 1 is updated to the first target file, the data file s10 previous to the current second target file in the data column is updated to the second target file, s7 and s10 are merged to obtain the updated data files {s7, s10}, and so on, until all the data files in each data block are merged.

In technical solutions of this embodiment, the current first target file and the current second target file in the data column composed of data files in the data block are merged to obtain the updated data files, the data file next to the current first target file in the data column is taken as a new first target file, the data file previous to the current second target file in the data column is taken as a new second target file. The new first target file and the new second target file are continuously merged to obtain the updated data files until all the data files in each data block are merged, thereby realizing the process of merging the data files in pairs.

As shown in FIG. 7, FIG. 7 is a schematic flowchart of the data file distribution method according to a sixth embodiment of the present disclosure. Operations S151 to S152 in the sixth embodiment are detailed operations of operation S150 in the fifth embodiment, and the sixth embodiment includes the following operations:

Operation S151, placing the current first target file and the current second target file in the data column composed of data files in each data block to a first distributed node; and

Operation S152, placing the data file next to the current first target file in the data column and the data file previous to the current second target file in the data column to a second distributed node, until all the data files in all the data blocks are placed on corresponding distributed nodes.

In this embodiment, when the data files are merged in pairs until the number of the data files reaches the number of the distributed nodes, the data files are placed on the corresponding distributed nodes. The process for placing the data files includes: placing the current first target file and the current second target file in the data column composed of data files in each data block to the first distributed node; and placing the data file next to the current first target file in the data column and the data file previous to the current second target file in the data column to the second distributed node, until all the data files in all the data blocks are placed on corresponding distributed nodes. For example, based on the fifth embodiment, the final result of merging data files in pairs is ({s8, s1}, {s7, s10}, {s9, s2}, {s12, s4}, {s5, s11}, {s3, s6}). The first target file ({s8, s1} and the second target file {s3, s6} in the data column composed of data files in the data block, namely {s8, s1, s3, s6}, are placed to the first distributed node. The data file {s7, s10} next to the current first target file in the data column and the data file {s5, s11} previous to the current second target file in the data column, namely {s7, s10, s5, s11}, are placed to the second distributed node, until all the data files in all the data blocks are placed.

In technical solutions of this embodiment, the current first target file and the current second target file in the data column composed of data files in each data block are placed to the first distributed node, and the data file next to the current first target file in the data column and the data file previous to the current second target file in the data column are placed to the second distributed node, until all the data files in all the data blocks are placed. Thus, the data files are evenly placed to the corresponding computer nodes.

Based on the same inventive concept, the present disclosure also provides a data file distribution device. As shown in FIG. 9, FIG. 9 is a schematic structural diagram of a data file distribution device according to the present disclosure. The data file distribution device includes: a sorting module 10, a dividing module 20, a merging module 30, and a placing module 40. Each module will be described below.

The sorting module 10 is for sorting data files according to an access frequency of each data file, a sorting mode including an ascending order or a descending order.

The dividing module 20 is for dividing the data files into at least two data blocks according to a sorted order, number of the data files in each data block being equal. Further, the dividing module 20 is for determining a target number according to the number of the data files and the number of the distributed nodes; and dividing the data files into data blocks with the target number according to a sorted order. Further, the dividing module 20 is for obtaining a first ratio between the number of the data files and a multiple of the number of the distributed nodes; and using the first ratio as the target number.

The merging module 30 is for merging the data files in each of the at least two data blocks in pairs to update the data files. Further, the merging module 30 is for merging a current first target file and a current second target file in a data column composed of the data files in each data block to obtain the updated data files, when merging for the first time, the current first target file being a data file at a first position of the data column, the current second target file being a data file at a last position of the data column; updating a data file next to the current first target file in the data column as a new first target file, updating a data file previous to the current second target file in the data column as a new second target file; and merging the new first target file and the new second target file in the data column composed of the data files in each data block to obtain the updated data files, until all the data files in each data block are merged.

The placing module 40 is for placing the data files on corresponding distributed nodes. Further, the placing module 40 is for placing the current first target file and the current second target file in the data column composed of data files in each data block to a first distributed node; and placing the data file next to the current first target file in the data column and the data file previous to the current second target file in the data column to a second distributed node, until all the data files in all the data blocks are placed on corresponding distributed nodes.

Since a device including a sorting module, a dividing module, a merging module, and a placing module is adopted, a hardware virtual device is provided for the data file distribution method, which solves the problem that the unbalanced data file distribution in the prior art leads to load-balancing problem, and improves the stability of the distributed system.

Based on the same inventive concept, the embodiments of the present disclosure also provide a computer storage medium. The computer storage medium stores a data file distribution program. When the data file distribution program is executed by a processor, each operation of the data file distribution method described above is implemented, and can achieve the same technical effect, in order to avoid repetition, which will not be repeated here.

Since the computer storage medium provided by the embodiment of the present disclosure is a computer storage medium used to implement the method of the embodiment of the present disclosure, based on the method introduced in the embodiment of the present disclosure, those skilled in the art can understand the specific structure and deformation of the computer storage medium, so it will not be repeated here. All computer storage media used in the methods of the embodiments of the present disclosure belong to the scope of the present disclosure.

The sequence numbers of the above-mentioned embodiments of the present disclosure are only for description, and do not represent the advantages and disadvantages of the embodiments.

Those skilled in the art should understand that the embodiments of the present disclosure can be provided as a method, a system, or a computer program product. Therefore, the present disclosure can adopt the form of a complete hardware embodiment, a complete software embodiment, or an embodiment combining software and hardware. Moreover, the present disclosure can take the form of a computer program product implemented on one or more computer-usable computer storage media (including but not limited to disk storage, CD-ROM, optical storage, etc.) containing computer-usable program codes.

The present disclosure is described with reference to flowcharts and/or block diagrams of methods, devices (systems), and computer program products according to embodiments of the present disclosure. It should be understood that each process and/or block in the flowchart and/or block diagram, and the combination of processes and/or blocks in the flowchart and/or block diagram can be realized by computer program instructions. These computer program instructions can be provided to the processor of a general-purpose computer, a special-purpose computer, an embedded processor or other programmable data processing equipment to produce a machine, such that the instructions executed by the processor of the computer or other programmable data processing equipment generate means for implementing the functions specified in one or more processes in the flowchart and/or one block or more in the block diagram.

These computer program instructions can also be stored in a computer-readable memory that can guide a computer or other programmable data processing equipment to work in a specific manner, such that the instructions stored in the computer-readable memory produce an article of manufacture including an instruction device that implements the functions specified in one process or multiple processes in the flowchart and/or one block or multiple blocks in the block diagram.

These computer program instructions can also be loaded on a computer or other programmable data processing equipment, so that a series of operations are executed on the computer or other programmable equipment to produce computer-implemented processing, and the instructions executed on a computer or other programmable device provide operations for implementing functions specified in a flow or multiple flows in the flowchart and/or a block or multiple blocks in the block diagram.

It should be noted that in the claims, any reference signs located between parentheses should not be constructed as limitations on the claims. The word “comprising”, “including” does not exclude the presence of components or operations not listed in the claims.

The word “a” or “an” preceding a component does not exclude the presence of multiple such components. The present disclosure can be implemented by means of hardware including several different components and by means of a suitably programmed computer. In the unit claims enumerating several devices, several of these devices may be embodied in the same hardware item. The use of the words “first”, “second”, and “third” etc. does not indicate any order, and these words can be interpreted as identifiers.

Although the optional embodiments of the present disclosure have been described, those skilled in the art can make additional changes and modifications to these embodiments once they learn the basic creative concept. Therefore, the appended claims are intended to be interpreted as including the optional embodiments and all changes and modifications falling within the scope of the present disclosure.

Obviously, those skilled in the art can make various changes and modifications to the present disclosure without departing from the spirit and scope of the present disclosure. In this way, if these modifications and variations of the present disclosure fall within the scope of the claims of the present disclosure and their equivalent technologies, the present disclosure is also intended to include these modifications and variations.

What is claimed is:

1. A data file distribution method, comprising operations of:
sorting data files according to an access frequency of each data file, a sorting mode including an ascending order or a descending order;
dividing the data files into at least two data blocks according to a sorted order, numbers of data files in the at least two data blocks being equal;
merging the data files in each of the at least two data blocks in pairs to update the data files;
sorting the updated data files according to the access frequency of each data file until the numbers of the data files are equal to numbers of distributed nodes; and
placing the data files on corresponding distributed nodes.

2. The data file distribution method of claim 1, wherein the operation of dividing the data files into at least two data blocks according to a sorted order comprises:
determining a target number according to the numbers of the data files and the numbers of the distributed nodes; and
dividing the data files into data blocks with the target number according to the sorted order.

3. The data file distribution method of claim 2, wherein the operation of determining a target number according to the numbers of the data files and the numbers of the distributed nodes comprises:
obtaining a first ratio between the numbers of the data files and a multiple of the numbers of the distributed nodes; and
using the first ratio as the target number.

4. The data file distribution method of claim 1, wherein before the operation of sorting data files according to an access frequency of each data file, the method further comprises:
obtaining a second ratio between the numbers of the data files and the numbers of the distributed nodes; and
when the second ratio is a non-integer, generating virtual files as data files, and setting access frequencies of the generated data files to zero.

5. The data file distribution method of claim 1, wherein the operation of merging the data files in each data block in pairs to update the data files comprises:
merging a current first target file and a current second target file in a data column composed of data files in each data block to obtain updated data files, the current first target file being a data file at a first position of the data column, and the current second target file being a data file at a last position of the data column when merging for the first time;
updating a data file next to the current first target file in the data column as a new first target file, and updating a data file previous to the current second target file in the data column as a new second target file; and
merging the new first target file and the new second target file in the data column composed of the data files in each data block to obtain updated data files, until all the data files in each data block are merged.

6. The data file distribution method of claim 1, wherein an access frequency of a new data file obtained by merging two data files is a sum of access frequencies of the two data files before merging.

7. The data file distribution method of claim 5, wherein the operation of placing the data files on corresponding distributed nodes comprises:
placing the current first target file and the current second target file in the data column composed of data files in each data block to a first distributed node; and
placing the data file next to the current first target file in the data column and the data file previous to the current second target file in the data column to a second distributed node, until all the data files in all the data blocks are placed on corresponding distributed nodes.

8. A smart device, comprising a memory, a processor, and a data file distribution program stored in the memory and executable on the processor, the data file distribution program, when executed by the processor, implements operations of the data file distribution method of claim 1.

9. A non-transitory computer readable storage medium, wherein a data file distribution program is stored in the computer readable storage medium, the data file distribution program, when executed by a processor, implements operations of the data file distribution method of claim 1.
